(19) United States
(12) Patent Application Publication
(10) Pub. No.: US 2014/0316715 A1
(43) Pub. Date: Oct. 23, 2014

(54) METHOD OF AUTOMATICALLY SETTING UNIT OF MEASUREMENT OF BIO-DATA MEASURING DEVICE

(71) Applicant: Philosys Co., Ltd., Gunsan-si, Jeollabuk-do (KR)

(72) Inventors: In Hwan Choi, Suwon-si (KR); Jeong In Bag, Anyang-si (KR)

(73) Assignee: Philosys Co., Ltd., Gunsan-si, Jeollabuk-do (KR)

(21) Appl. No.: 14/366,747

(22) PCT Filed: Dec. 24, 2012
(86) PCT No.: PCT/KR2012/011389

§ 371 Date: Jun. 19, 2014

(30) Foreign Application Priority Data
Dec. 26, 2011 (KR) 10-2011-0142325

(51) Int. Cl. G06F 19/24

(52) U.S. Cl. CPC G06F 19/24
USPC 702/19

(57) ABSTRACT

The present invention relates to a method of automatically setting a unit of measurement of a bio-data measuring device. The bio-data measuring device automatically sets a country belonging to a corresponding location as location information is determined, and automatically selects a unit of measurement of the set country depending on automatic setting for countries. When bio-data is measured by measurement means, operation means calculates a bio-data measurement value depending on a reference unit and a calculation formula, and determines whether the automatically selected unit of measurement of the set country is identical to the reference unit. If the automatically selected unit of measurement is not identical to the reference unit, the operation means converts the calculated bio-data measurement value into a numerical value based on the automatically selected unit of measurement of the set country. The converted numerical value and the automatically selected unit of measurement are displayed.

### TECHNICAL FIELD

The present invention relates, in general, to a method of automatically setting the unit of measurement of a bio-data measuring device and, more particularly, to a method of automatically setting the unit of measurement of a bio-data measuring device, which automatically sets the unit of measurement of the bio-data measuring device depending on setting for different countries, thus enhancing safety and commercialization.

### BACKGROUND ART

A bio-data measuring device denotes a device for analyzing biological components, such as glucose, protein, ketone body, bilirubin, occult blood, and/or nitrite, from a biological sample (bio-sample). Recently, with the development of medical technology and an increase in concern for health, demands for portable bio-data measuring devices, in particular, have increased.

Most biological samples used for bio-data measuring devices are liquid materials acquired from the inside of the body of a user, and such a bio-data measuring device obtains desired data by measuring the amount of specific desired material that is present in the unit volume of liquid material. For example, various types of bio-data measuring devices that are sold domestically in Korea generally use mg/dl as the unit of measurement, but bio-data measuring devices that are sold in Europe generally use mmol/l as the unit of measurement.

However, bio-data measuring devices are manufactured in other countries as well. Accordingly, when the bio-data measuring devices manufactured to use mg/dl as the unit of measurement are sold to and used by consumers in countries in which mmol/l is generally used as the unit of measurement, there are problems in that the consumers may be confused by the unit of measurement, and the misunderstanding of numerical values may lead to the health of consumers being adversely affected, with potentially fatal results. In particular, a bio-data measuring device is disadvantageous in that it is common that the unit of measurement is either not displayed on a display or displayed in very small size, and in that the setting of the unit of measurement is impossible, and numerical values converted in the desired unit of measurement are not provided to consumers, thus inconveniencing users who use the bio-data measuring device.

Accordingly, in order to solve the conventional problems, the present inventors developed a method of automatically setting the unit of measurement of a bio-data measuring device, which can automatically set the unit of measurement of the bio-data measuring device depending on setting for different countries, can prevent confusion with regard to the unit of measurement, and can allow a user to freely change the unit of measurement, thus enhancing safety and commercialization.

### DISCLOSURE OF INVENTION

### Technical Problem

Accordingly, the present invention has been made keeping in mind the above problems occurring in the prior art, and an object of the present invention is to provide a method of automatically setting the unit of measurement of a bio-data measuring device, which can automatically set the unit of measurement of the bio-data measuring device depending on setting for different countries.

Another object of the present invention is to provide a method of automatically setting the unit of measurement of a bio-data measuring device, which can prevent a user from being confused by the unit of measurement.

A further object of the present invention is to provide a method of automatically setting the unit of measurement of a bio-data measuring device, which can allow a user to freely change the unit of measurement, thus enhancing safety and commercialization.

The above and other objects of the present invention can be achieved by the present invention which will be described later.

### Solution to Problem

In order to accomplish the above objects, the present invention provides a method of automatically setting a unit of measurement of a bio-data measuring device, including a) a bio-data measuring device having measurement means, operation means, and storage means for bio-data and also having a location information determination function and a setting function for different countries, the bio-data measuring device automatically setting a country belonging to a corresponding location as location information is determined, and automatically selecting a unit of measurement of the set country depending on automatic setting for different countries; b) when bio-data is measured by the measurement means, the operation means calculating a bio-data measurement value depending on a reference unit and a calculation formula previously stored in the storage means, and determining whether the automatically selected unit of measurement of the set country is identical to the reference unit; c) if the automatically selected unit of measurement of the set country is not identical to the reference unit, the operation means converting the calculated bio-data measurement value into a numerical value based on the automatically selected unit of measurement of the set country; and d) displaying the converted numerical value and the automatically selected unit of measurement of the set country.

Preferably, the bio-data measuring device at a) may include a Global Positioning System (GPS), wherein determination of the location information and setting for different countries are performed by the GPS.

Preferably, the bio-data measuring device may be a coupled body of a bio-data measurement module and a device having a location information determination function and a setting function for different countries, a) may be configured such that the setting for different countries and the determination of location information are configured to perform automatic setting for different countries by the device having the location information determination function and the setting function for different countries, b) may be configured such that the measurement of the bio-data is performed by the bio-data measurement module, and the calculation and determination are performed by the device having the location information determination function and the setting function for different countries, c) may be configured such that the conversion is performed by the device having the location information determination function and the setting function for different countries, and d) may be configured such that the display is performed by the device having the location information determination function and the setting function for different countries, and the bio-data measurement module may include a main body including therein a bio-data measurement unit for measuring bio-data of a sample absorbed by a test strip, and a central processing unit for calculating, storing, and transmitting results of measurement of the bio-data and information indicating that the bio-data measurement module has been coupled to the device having the location information determination function and the setting function for different countries; a test strip insertion slot formed in a portion of the main body and configured to have a structure enabling the test strip to be inserted into the test strip insertion slot; and a plug formed on one side surface of the main body 110 and configured to have a structure that can be coupled to a socket of the device having the location information determination function and the setting function for different countries.

Preferably, the device having the location information determination function and the setting function for different countries may be a smart phone, and the method may further include, before a), executing a bio-data measurement application of the smart phone.

Preferably, a) may further include allowing a user to change the automatically selected unit of measurement of the set country, and storing a changed unit of measurement of the set country.

### Advantageous Effects of Invention

The present invention is advantageous in that it can provide a method of automatically setting the unit of measurement of a bio-data measuring device, which can automatically set the unit of measurement of the bio-data measuring device depending on setting for different countries, can prevent a user from being confused by the unit of measurement, and can allow a user to freely change the unit of measurement, thus enhancing safety and commercialization.

### BRIEF DESCRIPTION OF DRAWINGS

FIG. 1 is a flowchart schematically showing a method of automatically setting the unit of measurement of a bio-data measuring device according to an embodiment of the present invention;

FIG. 2 is a perspective view schematically showing the appearance of a bio-data measurement module according to another embodiment of the present invention; and

FIG. 3 is a perspective view schematically showing the appearance of a bio-data measurement module and a smart phone according to a further embodiment of the present invention.

### BEST MODE FOR CARRYING OUT THE INVENTION

The above and other objects, features and advantages of the present invention will be more clearly understood from the following detailed description taken in conjunction with the accompanying drawings. Hereinafter, a method of automatically setting the unit of measurement of a bio-data measuring device according to embodiments of the present invention will be described in detail with reference to the attached drawings.

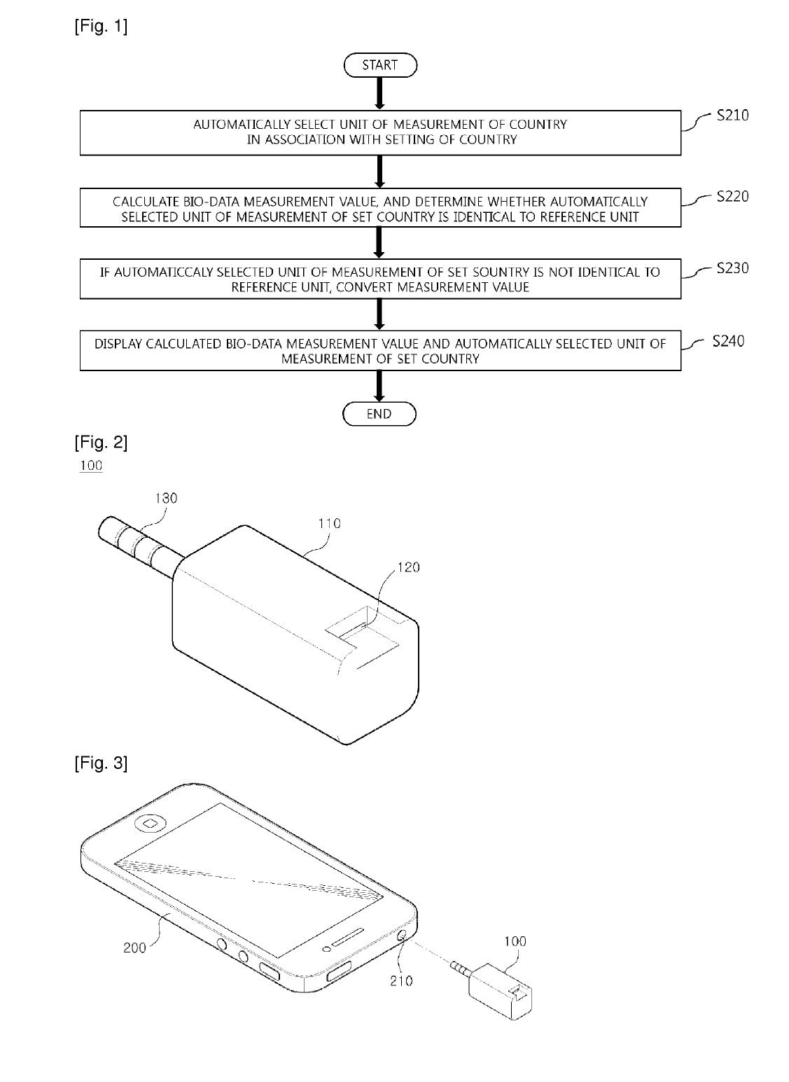

FIG. 1 is a flowchart schematically showing a method of automatically setting the unit of measurement of a bio-data measuring device according to an embodiment of the present invention.

As shown in FIG. 1, a method of automatically setting the unit of measurement of a bio-data measuring device according to an embodiment of the present invention includes steps S210 to S240. At step S210, a bio-data measuring device including a measurement means, an operation means, and a storage means for bio-data has a location information determination function and a setting function for different countries. Further, at step S210, as location information is determined, a country belonging to the corresponding location is automatically set, and the unit of measurement of the set country is automatically selected depending on automatic setting for different countries. At step S220, when bio-data is measured by the measurement means, the operation means calculates a bio-data measurement value depending on a reference unit and a calculation formula which are previously stored in the storage means, and determines whether the unit of measurement of the set country that has been automatically selected is identical to the reference unit. At step S230, if the automatically selected unit of measurement of the set country is not identical to the reference unit, the operation means converts the calculated bio-data measurement value into a numerical value based on the automatically selected unit of measurement of the set country. At step S240, the converted numerical value and the automatically selected unit of measurement of the set country are displayed.

First, the bio-data measuring device includes the measurement means, the operation means, the storage means, the location information determination function, and the setting function for different countries, and performs the step S210 of, as location information has been determined, automatically setting a country belonging to the determined location, and automatically selecting the unit of measurement of the set country depending on automatic setting for different countries. For example, the automatic setting for different countries can be performed in such a way that a device having a location information determination function, such as a Global Positioning System (GPS), determines the location information of the user and performs setting for the corresponding country depending on the determined location information. The unit of measurement of the country is automatically selected depending on the automatic setting of the corresponding country.

That is, during a process for manufacturing the bio-data measuring device of the present invention, the device is manufactured such that a device having a location information determination function and a setting function for different countries is included, and such that the unit of measurement of the corresponding country, which is generally used in the country, is associated with the country and automatically selected depending on the setting for different countries.

For example, when the bio-data measuring device is manufactured in China and is exported to Korea, if a Korean user selects Korea in the setting for different countries of the bio-data measuring device, or if setting for different countries has been automatically performed based on the location of the user in Korea, mg/dl, which is the unit of measurement generally used in Korea, is associated with the setting of the country and automatically selected. Further, when a bio-data measuring device is exported to Slovenia, if a Slovenian user selects Slovenia in the setting for different countries of the bio-data measuring device, or if setting for different countries has been automatically performed based on the location of the user in Slovenia, mmol/l, which is the unit of measurement generally used in Slovenia, may be associated with the setting of the country and may be automatically selected. However, when a user who lived in a country in which mmol/l is generally used goes to and lives in a country in which mg/dl is generally used, he or she may undergo difficulty in use because the unit of measurement of the country obtained based on the setting for different countries is different from the unit of measurement that is mainly used. Therefore, step S210 of the present invention may be configured to further include the step of allowing the user to change the unit of measurement for the corresponding country that has already been automatically selected, and storing the changed unit of measurement for the country, thus allowing foreigners who are not accustomed to the unit of measurement used in a specific country to more conveniently use the bio-data measuring device.

After step S210, the bio-data measuring device performs the step S220 of, when the measurement of bio-data is performed by the measurement means, the operation means calculating the bio-data measurement value depending on the reference unit and the calculation formula previously stored in the storage means, and determining whether the automatically selected unit of measurement of the set country is identical to the reference unit. Thereafter, if the automatically selected unit of measurement of the set country is identical to the reference unit, the calculated bio-data measurement value and the automatically selected unit of measurement of the set country are displayed.

However, after step S220, if it is determined that the automatically selected unit of measurement of the set country is not identical to the reference unit, the operation means performs the step S230 of converting the calculated bio-data measurement value into a numerical value based on the automatically selected unit of measurement of the set country. That is, since the bio-data measuring device includes the operation means for bio-data, the step S240 of converting the measurement value measured in the reference unit into a numerical value in the automatically selected unit of measurement of the set country, and displaying the converted numerical value and the automatically selected unit of measurement of the set country is performed.

FIG. 2 is a perspective view schematically showing the appearance of a bio-data measurement module according to another embodiment of the present invention, and FIG. 3 is a perspective view schematically showing the appearance of a bio-data measurement module and a smart phone according to a further embodiment of the present invention.

As shown in FIGS. 2 and 3, the bio-data measuring device according to the present invention may be implemented as a single device, but may be implemented as a coupled body of the bio-data measurement module and a device having a location information determination function and a setting function for different countries. In this case, a bio-data measurement module 100 includes a main body 110, a test strip insertion slot 120, and a plug 130. The main body 110 includes therein a bio-data measurement unit for measuring the bio-data of a sample absorbed by a test strip, and a central processing unit for calculating, storing, and transmitting the results of the measurement of the bio-data and information indicating that the bio-data measurement module has been coupled to the device having the location information determination function and the setting function for different countries. The test strip insertion slot 120 is formed in a portion of the main body 110 and has a structure enabling the test strip to be inserted into the slot 120. The plug 130 is formed on one side surface of the main body 110 and has a structure that can be coupled to the socket of the device having the location information determination function and the setting function for different countries. Further, the device having the location information determination function and the setting function for different countries can be implemented as any type of device including a GPS function among devices to which the bio-data measurement module can be coupled, but may preferably be implemented as a smart phone. A smart phone 200 has various functions, so that when the plug 130 of the bio-data measurement module 100 is coupled to the socket 210 of the smart phone 200, a coupled body of the bio-data measurement module 100 and the smart phone 200 can be usefully used as the bio-data measuring device.

When the coupled body of the bio-data measurement module 100 and the smart phone 200 is used as the bio-data measuring device according to the present invention, the user executes the bio-data measurement application program of the smart phone 200 before performing the method of automatically setting the unit of measurement of the bio-data measuring device according to the present invention. Accordingly, the method of automatically setting the unit of measurement of the bio-data measuring device can be performed on the application program.

Although the preferred embodiments of the present invention have been disclosed for illustrative purposes, those skilled in the art will appreciate that various modifications, additions and substitutions are possible, without departing from the scope and spirit of the invention. Therefore, the scope of the present invention should be defined by the technical spirit of the accompanying claims.

### INDUSTRIAL APPLICABILITY

The present invention can provide the unit of measurement of bio-data that is actually used by a user during the use of a bio-data measuring device, and can prevent confusion by the unit of measurement and the occurrence of dangerous situations caused by the erroneous reading of the unit of measurement, thus enabling the present invention to be widely used in various bio-data measuring devices.

1. A method of automatically setting a unit of measurement of a bio-data measuring device, comprising:
a) a bio-data measuring device having measurement means, operation means, and storage means for bio-data and also having a location information determination function and a setting function for different countries, the bio-data measuring device automatically setting a country belonging to a corresponding location as location information is determined, and automatically selecting a unit of measurement of the set country depending on automatic setting for different countries;
b) when bio-data is measured by the measurement means, the operation means calculating a bio-data measurement value depending on a reference unit and a calculation formula previously stored in the storage means, and determining whether the automatically selected unit of measurement of the set country is identical to the reference unit;
c) if the automatically selected unit of measurement of the set country is not identical to the reference unit, the operation means converting the calculated bio-data measurement value into a numerical value based on the automatically selected unit of measurement of the set country; and
d) displaying the converted numerical value and the automatically selected unit of measurement of the set country.

2. The method of claim 1, wherein the bio-data measuring device at a) comprises a Global Positioning System (GPS), wherein determination of the location information and setting for different countries are performed by the GPS.

3. The method of claim 1, wherein:
the bio-data measuring device is a coupled body of a bio-data measurement module and a device having a location information determination function and a setting function for different countries,
a) is configured such that the setting for different countries and the determination of location information are configured to perform automatic setting for different countries by the device having the location information determination function and the setting function for different countries,
b) is configured such that the measurement of the bio-data is performed by the bio-data measurement module, and the calculation and determination are performed by the device having the location information determination function and the setting function for different countries,
c) is configured such that the conversion is performed by the device having the location information determination function and the setting function for different countries, and
d) is configured such that the display is performed by the device having the location information determination function and the setting function for different countries, and
the bio-data measurement module comprises,
a main body including therein a bio-data measurement unit for measuring bio-data of a sample absorbed by a test strip, and a central processing unit for calculating, storing, and transmitting results of measurement of the bio-data and information indicating that the bio-data measurement module has been coupled to the device having the location information determination function and the setting function for different countries;
a test strip insertion slot formed in a portion of the main body and configured to have a structure enabling the test strip to be inserted into the test strip insertion slot; and
a plug formed on one side surface of the main body 110 and configured to have a structure that can be coupled to a socket of the device having the location information determination function and the setting function for different countries.

4. The method of claim 3, wherein:
the device having the location information determination function and the setting function for different countries is a smart phone, and
the method further comprises, before a), executing a bio-data measurement application of the smart phone.

5. The method of claim 1, wherein a) further comprises allowing a user to change the automatically selected unit of measurement of the set country, and storing a changed unit of measurement of the set country.
